(19) United States
(12) Patent Application Publication
(10) Pub. No.: US 2003/0187731 A1
(43) Pub. Date: Oct. 2, 2003

(54) System and method for providing incentives to users who browse information through a computerized network

(76) Inventors: Tetsuo Takakura, Tokyo (JP); Masaomi Sato, Tokyo (JP)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/112,059

(22) Filed: Apr. 1, 2002

(51) Int. Cl. G06F 17/60

(52) U.S. Cl. 705/14

(57) ABSTRACT

A system for providing information according to the present invention is a system with a configuration where a server device 1, and a client device 2 are connected to each other through the Internet 3 so that the devices may communicate each other. The server device 1 comprises a incentive DB 13 storing incentive-information for specifying the contents of incentives which are given to browsers who browse information, and a incentive-process section 16 by which the contents of incentives which are given to browsers browsing the information are stored in the incentive DB 13 after specifying. According to the present system, entirely new incentives for making browsers browse Web pages may be given.

### FIELD OF THE INVENTION

The present invention relates to a system, a device, a method, and a recording medium, for providing incentives to users who browse information through a computerized network.

### BACKGROUND OF THE INVENTION

In recent years, technologies related to the Internet have been rapidly widespread, and, more particularly, the WWW (World Wide Web) has been widely used. The WWW is a wide area information system using Hypertext, where Web pages stored in numerous WWW servers connected to the Internet are called, browsed, and so on through a client device.

In the WWW, providers, who provide different types of information in the form of Web pages, may easily transmit the information worldwide at a high speed and with low costs, and he may obtain advertising and promotional effects. On the other hand, browsers browsing for information receive different types of information worldwide at almost no cost.

As a consequence of this unlimited access to different types of information, it is becoming extremely difficult for information providers to attract browsers to their Web site, in view of the proliferation of Web sites that have been recently established, and the increasingly larger number of Web pages available to the public.

Generally speaking, here are two methods for solving the problem.

The first method is a method by which processing is performed inside the Web sites. Specifically, more browsers are attracted by enhancing the contents of each Web page in the Web sites.

However, in order to enhance the contents, it is required to study the future trends and so on of the contents, to collect a large amount of information, to analyze and synthesize the collected information, and, further, to make different types of designs, such as graphics, which are an expression form of information. But, the operations are not easy, as the amount of information, and special knowledge on the contents, furthermore, a sense for producing the contents, and so on are required. Especially, it is extremely difficult to have differentiated Web pages from other ones only by the substance of the contents, as the operations are usually performed in any Web sites on a large or small scale.

Alternatively, the other method is a method by which processing is performed outside the Web sites. Specifically, it is to attract more browsers by advertising the own Web sites to browsers. For example, portal sites for browsing guide by giving services for retrieval of Web sites and many Web advertisements for more access to the own Web pages from other Web ones by means of hyperlinks, and so on have been recently given.

However, if interests of browsers may not be aroused in the own Web pages among many Web sites, there may not be browsers browsing the own Web pages, as there have currently been many Web sites introduced by the portal sites, and a lot of Web sites published in advertisements.

In such situations, in order to attract the attention of browsers to specific Web pages, it is required to give new incentives, which have never been given, to the browsers.

### SUMMARY OF THE INVENTION

An object of this invention is to provide a system, a device, a method, and a recording medium, for providing incentives to users who browse information through a computerized network.

In order to achieve these objects, according to a first aspect of the present invention, there is provided a system for providing incentives to users who browse information through a computerized network comprising: an information terminal device for browsing different types of information; and an information providing device for providing information to the information terminal device through the network, wherein, said information providing device includes: an incentive-information database for storing incentive-information to represent contents of incentives given to the users who browse information with the information terminal device; and an incentive-process means for specifying the contents of incentives based on the user who browses information or the information terminal device used to browse information, and information which the users browse, and for storing incentive-information in the incentive-information database.

As described above, it has conventionally been difficult to give browsers incentives for browsing Web pages.

On the other hand, according to the first aspect, the contents of incentives to be given to browsers are specified, and are stored in the information providing device, when information is browsed. That is, when browsers browse information, predetermined incentives (for example, cash, virtual money, and so on, and the details will be described later) are given to the browsers. Accordingly, the incentives may be directly given to the browsers, and entirely new incentives for making browsers browse Web pages may be given.

Thereby, for example, when an individual makes Web pages, a reason for calling relatives and friends for the Web pages may be given, when an enterprise makes Web pages for advertisement of its own commodities, motives for attracting consumers and customers for the Web pages may be given, or, incentives may be given as a way, by which an donation investor makes donation to a volunteers organization, to the volunteers organization which has browsed the investor's Web pages.

Alternatively, the present invention relates to a information providing device, and according to a second aspect of the present invention, there is provided an information providing device for providing different types of information to an information terminal device through a computerized network comprising: an incentive-information database for storing incentive-information to represent contents of incentives given to the users who browse information with the information terminal device; and an incentive-process means for specifying the contents of incentives, based on the user who browses information or the information terminal device used to browse information, and information which the users browse, and for storing incentive-information in the incentive-information database.

According to the second aspect, when information is browsed, contents of incentives which are given to browsers browsing the information are specified and stored. That is, when the browsers browse the information, predetermined incentives are given to the browsers. Accordingly, the incentives may be directly given to the browsers, and entirely new incentives for making browsers browse Web pages may be given.

Moreover, a third aspect of the present invention provides the information providing device according to the second aspect, comprising an incentive-condition database for storing incentive-conditions for specifying the contents of incentives, wherein: the incentive-process means specifies the contents of incentives based on the incentive-conditions stored in the incentive-condition database.

According to the third aspect, the incentive conditions for specifying the contents of incentives are stored, and the contents of incentive are specified based on the incentive conditions. Accordingly, arbitrary incentives in agreement with intentions of Web page providers, those who establish the system, and so on may be given by appropriately setting the incentive conditions.

Furthermore, a fourth aspect of the present invention provides the information providing device according to the third aspect, wherein the incentive-conditions stored in the incentive-condition database are attribute conditions relating to predetermined attributes of predetermined said ones of users, and the incentive-process means specifies the contents of incentives based on the attribute conditions stored in the incentive-condition database.

According to the fourth aspect, attribute conditions for attributes of the browsers are stored, and the contents of incentives are specified based on the attribute conditions. Accordingly, incentives according to the browsers may be given, for example, incentives may be given only to specified browsers, and contents of incentives may be changed according to genders and ages and so on of the browsers.

In addition, a fifth aspect of the present invention provides the information providing device according to the third or fourth aspect, wherein the incentive conditions stored in the incentive-condition database are timing conditions relating to browsing times of said users, and the incentive-process means specifies the contents of incentives based on the timing conditions stored in the incentive-condition database.

According to the fifth aspect, the timing conditions for browsing timing by the browsers are stored, and the contents of incentives are specified based on the timing conditions. Accordingly, incentives according to the browsing timing may be given, for example, incentives are given only when browsing is performed during specific period, or amounts of incentives may be changed according to the browsing timing.

Alternatively, a sixth aspect of the present invention provides the information providing device according to any one of the second to fifth aspects, comprising an incentive-limiting-condition database for storing incentive-limiting-conditions for limiting the contents of incentives, wherein: the incentive-process means limits the contents of incentives based on the incentive-limiting-conditions stored in the incentive-limiting-condition database.

According to the sixth aspect, the incentive-limiting conditions for limiting the contents of incentives are stored, and the contents of incentives are limited based on the incentive-limiting conditions. Accordingly, arbitrary incentives in agreement with intentions of Web page providers, those who establish the system, and so on may be given by appropriately setting the incentive conditions.

Moreover, a seventh aspect of the present invention provides the information provide device according to the sixth aspect, wherein the incentive-limiting-conditions are conditions for the amount of incentives which said users have acquired, or the number of times which said users have acquired the incentives, and the incentive-process means limits the contents of incentives within the range of the amount of incentives or the number of times based on the incentive-limiting-conditions.

According to the seventh aspect, the conditions for the amount of incentives which have been acquired by the browsers, or the number of times which the browsers have acquired the incentives are stored, and the contents of incentives are limited within the range of the amount of incentives, or the number of times. Accordingly, for example, it is possible that the incentives are given to a same browser only once, the total sum of the incentives is limited to 10,000 yen or less, and so on, as the incentives which are given to the browsers are limited with in a predetermined amount of money, or number of times.

Furthermore, according to a eighth aspect of the present invention, there is provided a method for providing incentives to users who browse information in a system including: an information terminal device for browsing different types of information; and an information providing device for providing information to the information terminal device through a network, comprising the steps of: (a) acquiring information from network for specifying the users who browse information or the information providing device used to browse information; (b) specifying the contents of incentives to be given to the users based on the information acquired in the acquiring step (a); and (c) storing incentive-information in the information providing device to specify the contents of incentives specified in the specifying step (b).

According to the eighth aspect, the contents of incentives which are given to the browsers are specified and stored, when information is browsed. That is, when browsers browse information, predetermined incentives are given to the browsers. Accordingly, incentives may be directly given to browsers, and entirely new incentives for making browsers browse Web pages may be given.

In addition, a ninth aspect of the present invention provides the method for providing information according to the eighth aspect, comprising the further steps of: in said information providing device storing incentive-conditions for specifying the contents of incentives, in said information providing device, wherein, the contents of the incentives specified in the specifying step (b) are based on the incentive-conditions.

According to the ninth aspect, the incentive conditions for specifying the contents of the incentives are stored, and the contents of the incentives are specified based on the incentive conditions. Accordingly, arbitrary incentives in agreement with intentions of Web page providers, those who establish the system, and so on may be given by appropriately setting the incentive conditions.

Alternatively, a tenth aspect of the present invention provides the method for providing information according to the eighth or ninth aspect, comprising the further steps of: storing the incentive-limiting-conditions, which are conditions for limiting the contents of incentives, in said information providing device, wherein, the contents of incentives are limited in the specifying step (b), based on the incentive-limiting-conditions.

According to the tenth aspect, the incentive-limiting conditions for limiting the contents of incentives are stored, and the contents of incentives are limited based on the incentive-limiting conditions. Accordingly, incentive limitation in agreement with intentions of Web page providers, those who establish the system, and so on may be realized by appropriately setting the incentive-limiting conditions.

Moreover, the present invention relates to a recording medium, and according to a eleventh aspect of the present invention, there is provided a computer-readable recording medium, comprising wherein a computer program for a computer to execute the method for providing information.

According to the eleventh aspect, the method for providing information according to any one of the eighth to tenth aspects may be realized with use of a computer by making the computer read programs recorded in the recording medium and executing the programs, and similar effects to those of the methods may be obtained.

Here, “computer-readable recording medium” includes, arbitrary “physical medium for portable use” such as floppy disks, magneto optical disks, ROMs (Read-Only Memories), EPROMs (Erasable Programmable Read-Only Memories), EEPROMs (Electrically Erasable Programmable Read-Only Memories), CD-ROMs (Compact Disc Read-Only Memories), and DVDs (Digital Versatile Disks), arbitrary “physical medium for fixed use” such as ROMs, RAMs (Random Access Memories), and HDs (Hard Disks) which are built into various kinds of computer systems, or “communication medium”, such as communication lines and carrier waves in the case of transmission of programs through a network such as LANs, WANS, and the Internet, by which programs are kept in a short term.

Furthermore, “program” is a data processing method described in an arbitrary language, and description method, and does not depend on forms such as source codes and binary codes. Here, “program” is not necessarily limited to one with a unified configuration, and includes a plurality of modules, ones which are configured as a library in a distributed manner, and ones which realize their function under cooperation with different programs such as OS (Operating System). Moreover, well-known configurations and procedures may be used for a specific configuration for reading a recording medium, reading procedures, installing procedures after reading, and so on in each device shown in the embodiment.

Other objects and features of this invention will become understood from the following description with reference to the accompanying drawings.

### BRIEF DESCRIPTION OF DRAWINGS

FIG. 1 is a block diagram showing a whole configuration of a system for providing information according to an embodiment of the present invention.

FIG. 2 is a view which shows a configuration example of information stored in a member DB.

FIG. 3 is a view which shows a configuration example of information stored in an incentive-condition DB.

FIG. 4 is a view which shows a configuration example of information stored in a incentive-limiting condition DB.

FIG. 5 is a view which shows a configuration example of information stored in a incentive DB.

FIG. 6 is a flow chart for incentive specifying/storing processing.

FIG. 7 is a flow chart for browsing processing.

FIG. 8 is a view which shows a display example of a VM browsing screen.

### DETAILED DESCRIPTIONS

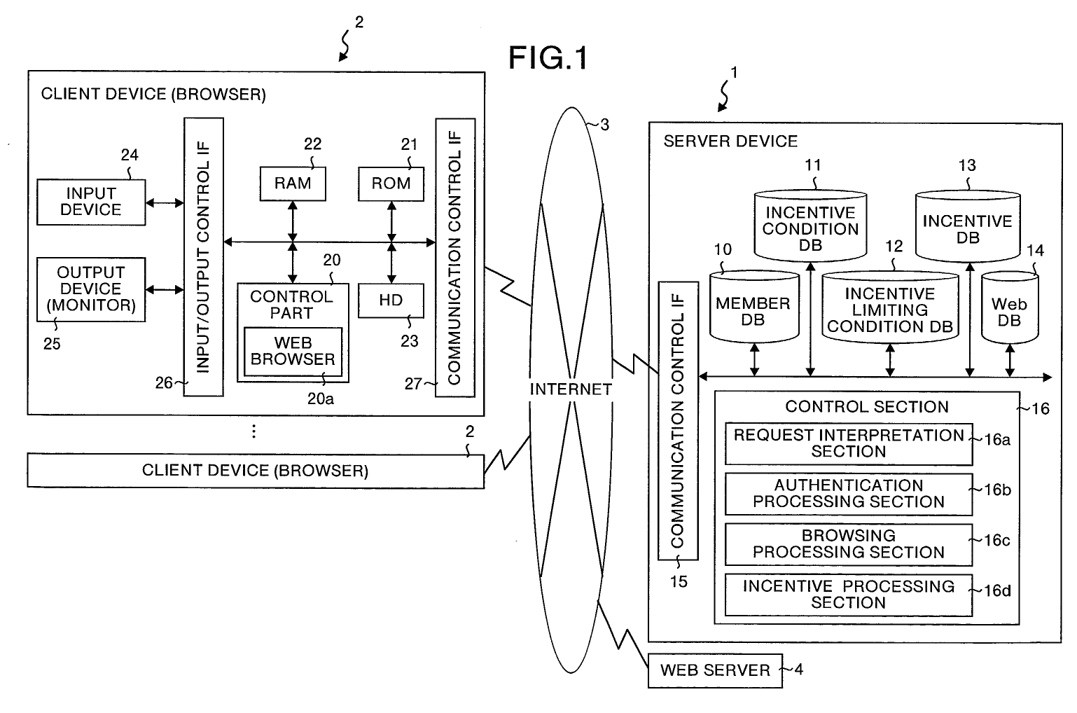

FIG. 1 is a block diagram of the overall configuration of the present invention wherein.

A server device 1 which is an information providing device providing different types of information such as Web pages, and a plurality of client devices 2 which are information terminal devices are connected to the server device 1 through the Internet 3. Moreover, an arbitrary Web server 4 is connected to the Internet 3.

The server device 1 is configured as an ISP (Internet Service Provider) server which an ISP has. Persons who browse Web pages (hereinafter, called as browsers) may log on the server device 1 to the client device 2, and may have an access to the Web server 4 to the server device 1. In such a system, it is assumed that the browsers are registered as members for the present system.

A basic feature distinguishing the present system from conventional ones lies in a point that the browsers which have browsed Web pages obtain incentives.

Though the predetermined incentives may include everything, such as points and various kinds of discounted charges which may be used for cash, gift certificates, giveaways, arbitrary commodities, purchase of service, and so on The predetermined incentives in the present embodiment is of virtual money (hereinafter, called as VM) which may be used as a money in predetermined sites on the Internet 3. Here, investors of the incentives (persons and enterprises which provide financial funds) are arbitrary, for example, authors of the Web pages may provide the funds, and builders of the present system may do so for promotion of the use of the present system, and so on.

The incentives which the browsers obtain are determined based on predetermined incentive conditions. Attributes of the browsers and browsing timing may be listed as the incentive conditions. That is, the incentives which browsers obtain may be increased or decreased according to the facts such as what kinds of browsers have browsed, and at what timing the browsing is performed by the browsers.

The incentives which the browsers obtain are limited based on predetermined incentive-limiting conditions. A number of times the incentives are received may be listed as one of the incentive-limiting conditions. For example, the number of times which a same browser may obtain incentives from a same Web page is limited by a predetermined number of times (for example, only once).

(System Configuration-Server Device 1)

A configuration of the present system will be described.

At first, a configuration of the server device 1 will be described.

In FIG. 1, the schematic configuration of the server device 1 comprises, a member DB (DB=database) 10, a incentive-condition DB 11, a incentive-limiting condition DB 12, a incentive DB 13, a Web DB 14, a communication control IF (IF=interface) 15, and a control section 16, and the each section are connected to each other through an arbitrary communication channel so that the each section may communicate each other. In addition, the server device 1 is connected to the Internet 3 through a communication device such as a router, and a dedicated line (the communication device and the dedicated line are not shown in the drawings) so that communication between the server device 1 and the Internet is possible.

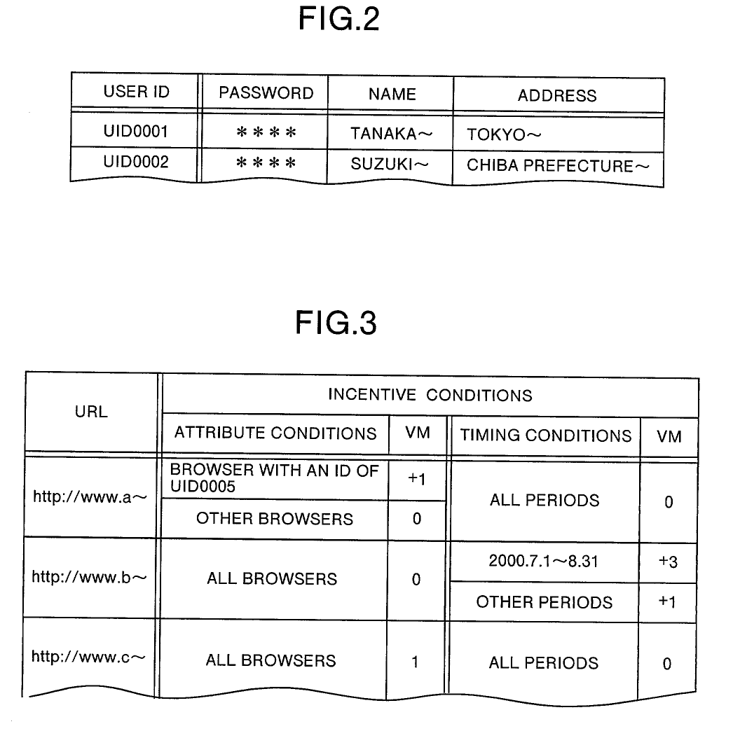

Among components of the server device 1, the member DB 10 is a database which stores member information that stores information related with browsers registered as members of the present system. Specifically, the information stored in the member DB 10 has, for example, a configuration where user IDs for identifying browsers uniquely, passwords for authentication of the browsers, names of the browsers, and addresses of the browsers are mutually related to each other as shown in FIG. 2. Here, arbitrary information, as well as the information, for specifying the attributes of the browsers may be stored as information on the browsers, and, for example, ages, genders, jobs, birth places, hobbies, and so on of the browsers may be stored.

The incentive-condition DB 11 is a database which stores incentive-conditions for specifying the contents of incentives. Specifically, the information stored in the incentive-condition DB 11 has, for example, a configuration where URLs (uniform resource locators) of the Web pages (or IP addresses of the Web pages) to be browsed, and incentive conditions (attribute conditions and timing conditions, here) are mutually related to each other as shown in FIG. 3.

Among the conditions, the attribute conditions are conditions related with attributes of the browsers. Specifically, as the attribute conditions, user IDs of the browsers, who may receive incentives by browsing each Web page, and VM which is contents of the incentives which are given to each browser are stored. For example, when browsers refer to a Web page of “URL =http://www.a-”, VM=1 is given to a browser with an ID of “User ID=UID0005”, and other browsers obtain VM=0 (the incentives are not given), in FIG. 3.

As described above, incentives according to the browsers may be given by specifying attribute conditions. For example, incentives may be given only to browsers (relatives, friends, customers, and so on) who have special relations with providers of Web pages.

However, absolute or relative attribute conditions, as well as the conditions, for identifying browsers who may receive incentives or those who may not do so may be stored as attribute conditions.

Ages, genders, jobs, birth places, hobbies, and so on of the browsers may be listed as the absolute attribute conditions. Further, a condition that the browsers are required to be younger than providers of the Web pages, and a condition that the genders of the browsers are opposite to those of the providers may be listed as the relative attribute conditions.

It may be configured that incentives are given only to “browsers who are 60 years old or more”, ”female browsers”, or “browsers who are younger than providers of the Web pages”. Here, information which is required for judging the attribute conditions is previously stored in the user ID.

The timing conditions are conditions relating to browsing times of said browsers. Specifically, dates when incentives may be given by browsing each Web page are stored as the timing conditions. For example, when browsers refer to a Web page of “URL=http://www.b-”, VM=3 is given to browsers who browse at “browsing timing=2000. 7. 1-2000. 8. 31”, and VM=1 is given to browsers who browse at different timing, according to FIG. 3.

As described above, the incentives may be given according to the browsing timing of browsers by specifying the timing conditions. For example, only when a Web page is browsed on a specified date (such as a campaign period, a founding anniversary, and a birthday), specially-additional VM may be given.

However, absolute or relative time conditions for specifying browsers who may receive incentives, and timing during which incentives may not be received, as well as the conditions, may be stored as timing conditions.

For example, the dates may be set as absolute time conditions.

Conditions such as “the incentives may be given when a number of accesses to a same Web page becomes 10,000”, “the incentives may be given when 1,000 or more browsers access to a same Web page at the same time”, and “the incentives may be given in the case of a same browser when access is made at intervals of one day or more”, may be stored as relative time conditions, and the incentives may be given, only when one of the condition is met.

Though the incentive conditions are set as conditions for each Web page here, across-page incentive conditions for a plurality of Web pages may be set.

For example, twice the VM may be given when a certain specific Web page is browsed, and Web pages which are related with the specific Web page are browsed in successions, that is, the incentives may be given according to net surfing paths. In this case, browsing paths through Web pages according to which special incentives are given are previously stored in the incentive-condition DB 11, paths according to which browsers have browsed Web pages are stored in the server device 1 for each browsing of a Web page, and it may be judged by comparing both paths at each browsing whether the incentives are required to be given or not.

The kinds of the incentives to be given may be changed according to the browsed Web pages. For example, gift certificates of a specific department store may be given, when a Web page of the specific department store is browsed, and points which may be used at a specific discount store may be given, when a Web page of the specific discount store is browsed. In this case, each URL, and information for specifying the kinds of the incentives which are given to browsers of a Web page specified by the each URL are previously stored in the incentive-condition DB 11, and the kinds of the incentives which are given to the browsers may be specified at each browsing, referring to the incentive-condition DB 11.

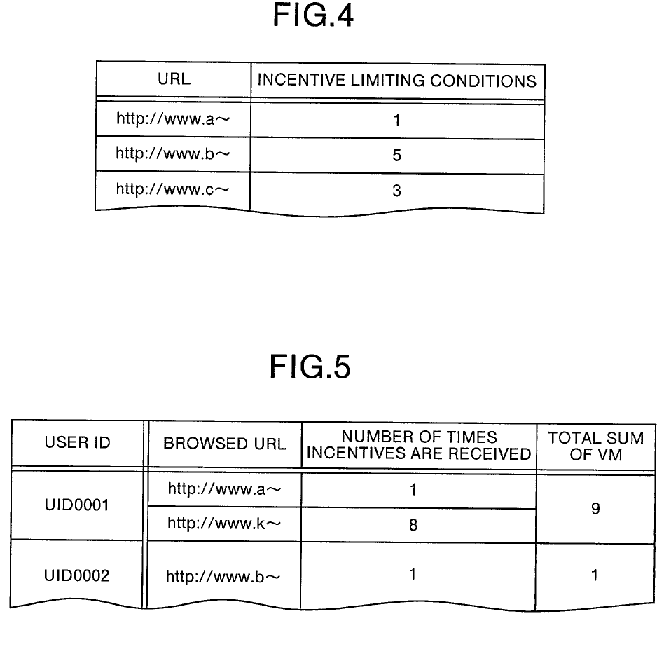

In FIG. 1, the incentive-limiting-condition DB 12 is a database which stores incentive-limiting-conditions for limiting the contents of incentives. Specific information stored in the incentive-limiting condition DB 12 has, for example, a configuration where URLs of Web pages to be browsed (or, IP addresses of the Web pages), and incentive-limiting conditions (upper limits of the VM given to a same browser on each Web page, here) are related with each other, as shown in FIG. 4.

However, absolute or relative conditions, as well as the conditions, for specifying browsers to whom limited incentives are given, or those to whom unlimited incentives are given may be stored as incentive-limiting conditions.

Among these conditions, upper limit amounts of money for giving cash, upper limit face amounts and upper limit number of sheets for giving gift certificates, and upper limit number of points for giving points, upper limit discounts, and upper limit discount number of times for discounting, and so on may be listed as absolute conditions. Further, conditions such as “the total sum of VM, which is given to all the browsers who have browsed a same Web page is made a predetermined value or less” may be stored as relative conditions. The incentives may be determined, based on the conditions.

Though the incentive conditions are set as conditions for each Web page here, across-page incentive conditions for a plurality of Web pages may be set.

For example, the total amount of the incentives which are given to the same browser who browses a plurality of Web pages may be set.

In FIG. 1, the incentive DB 13 is a incentive-information database which stores incentive-information to represent contents of incentives given to the users who browse information with the information terminal device. Specific information stored in the incentive DB 13 has, for example, a configuration where user IDs of each browser, URLs of Web pages which the each browser has browsed so far, number of times which the each browser has obtained the incentives by browsing each Web page, and the total sum of the VM which has been currently given to each browser are related with each other, as shown in FIG. 5.

The Web DB 14 is Web storage unit which stores data which form different types of Web pages browsed at the client device 2 (hereinafter, called as Web data), and programs for the forming. The contents of the Web data are arbitrary, and the data format is formed as a text file which has been described in HTML and XML. In addition, the Web DB 14 may store voices, in a voice file form such as a WAVE form and a AIFF one, to be transmitted to the client device 2, and still pictures and moving ones in an image file form such a JPEG form, and an MPEG 2 one, as required.

The communication control IF 15 performs communication control between the server device 1 and the Internet 3 (or, a communication device such as a router) in FIG. 1.

In FIG. 1, the control section 16 has a conceptual and functional configuration comprising a request interpretation section 16a, an authentication-processing section 16b, a browsing processing section 16c, and a incentive-processing section 16d.

Among the sections, the request interpretation section 16a is a request interpretation unit which interprets request contents from the client device 2, and delivers processing to other sections in the control section 16 according to the interpretation results. Further, the authentication-processing section 16b is an authentication-processing unit which receives the authentication request from the client device 2, and for authentication judgment. Moreover, the browsing processing section 16c is a browsing processing unit which calls, generates, and transmits a Web page after receiving browsing request of the Web page from the client device 2. Furthermore, the incentive processing section 16d is a incentive-process means which specifies and stores incentive contents. In addition, the details of processing at the sections will be described later.

Though the configuration of the server device 1 has been described above, each component shown in the drawings has been expressed in a conceptual and functional manner, and the configuration is not necessarily required to be made as shown above in a physical manner.

For example, with regard to processing functions that each server of the server device 1 is provided with, and, more particularly, each processing function performed at the control section 16, all or an arbitrary part of the functions may be realized by a CPU (Central Processing Unit), and programs that are interpreted and executed in the CPU, or, by hardware with wired logic. Here, the programs are stored in a recording medium (not shown), and are mechanically read in the server device 1, as required.

Specific distributing/integrating configurations for the server device 1 are not limited to the one shown in the drawings, but all parts or a part of the device may be configured to be distributed/integrated in an arbitrary unit according to various kinds of loads and so on in a functional or physical manner. For example, the Web DB 14 may be configured to be independently provided as a Web server, or the incentive-condition DB 11 and the incentive DB 13 may be configured to be integrated as one DB.

A fire wall server, a DNS (Domain Name System) server, a mail server, an FTP (File Transfer Protocol) server and so on may be further added as a component function of the actual server device 1, and, the servers are actually arranged as separate servers independently. But, as well-known configurations may be applied to the servers, the description for the servers will be eliminated.

(System Configuration-Client Device 2)

A configuration of the client device 2 will be described.

As shown in FIG. 1, the schematic configuration of the client device 2 comprises, a control section 20, a ROM section 21, a RAM section 22, an HD section 23, an input device 24, an out device 25, an input/output control IF 26, and a communication control IF 27, and the each section are connected to each other through a bus so that the each section may communicate each other.

The client device 2 may be realized by, for example, a personal computer, a workstation, a household game machine (SEGA ENTERPRISES, LTD. made Dream Cast, and so on), an Internet TV, a PDA (Personal Digital Assistant), or a mobile communication terminal, such as a cellular telephone, and PHS (Personal Handy Phone System).

The control section 20 of the client device 2 has a configuration comprising a Web browser 20a. Among the components, the Web browser 20a fundamentally interprets Web data, and performs display control (browsing processing) for display the data on a monitor 25 which will be described later.

All or an arbitrary part of the processing at the control section 20 may be realized by a CPU or programs which are interpreted and executed in the concerned CPU. That is, computer programs for giving instructions to the CPU, and performing various kinds of processing under cooperation with an OS (Operating System) are stored in the ROM 21 or HD 23. The computer programs are executed after loading into the RAM 22, and forms the control section 20 under cooperation with the CPU.

However, the computer programs may be stored in an application program server which is connected to the client device 2 through the arbitrary Internet 3, and all or a part of the programs may be down-loaded as required. Alternatively, all or an arbitrary part of the control section 20 may be realized by hardware with wired logic.

A keyboard, a mouse, a microphone, and so on may be used as the input device 24. Furthermore, the monitor 25 which will be described later also realizes a pointing device under cooperation with the mouse. The contents input with the input device 24 are sent to the control section 20 through the input/output control IF 26.

A speaker, as well as the monitor (including a household television), may be used as the output device 25 (hereinafter, description is made, assuming that the output device 25 is configured to be the monitor 25). The output contents for the output device 25 are sent from the control section 20 through the input/output control IF 26.

The client device 2 with the configuration is connected to the Internet 3 through the communication control IF 27, a communication device such as a modem, a TA (terminal adapter), and a router, and a telephone line or the dedicated line, and may access to the server device 1 according to a predetermined protocol (for example, TCP/IP Internet protocol).

(Network)

A network connecting the server device 1 and the client device 2 is not limited to the Internet 3, but an arbitrary network may be used as the network connecting the devices. For example, the present system may be constructed in a limited area, using a LAN, a WAN or a personal computer communication net. Moreover, various kinds of data may be transmitted and received through a ground wave, a CATV (cable television), a CS (communication satellite), a BS (broadcasting satellite) or an ISDB (Integrated Services Digital Broadcasting). That is, not only cable networks, but the radio and communication networks may be also included in the present network.

(Details of Processing Contents)

Contents of processing which is performed using the present system with the configuration will be described in detail.

(Details of Processing Contents-Assumption)

It is assumed that attribute information of browsers who are members of the present system is stored in a member DB 10. Registration may be performed by a well-known method, for example, the control section 16 in the server device 1 analyzes input contents, when browsers display a predetermined Web page for member registration on the Web browser 20a in the client device 2, and input required items such as the attribute information into the Web page. When the registration is admitted, a user ID and an initial password are issued by a predetermined method (for example, based on a sequential generation of numbers, a random one, and so on), a Web page including the information is displayed on the Web browser 20a, and, at the same time, the information is stored in the member DB 10.

It is assumed that URLs of Web pages by which the incentives are given in the present system, and the incentive conditions are stored in the incentive-condition DB 11. The registration may be performed by a well-known method, for example, the incentive conditions and so on are stored in the incentive-condition DB 11 by uploading a data file storing the URLs and incentive conditions which are related to each other to the server device 1 according to a predetermined communication protocol (for example, the FTP protocol), when those who establish the present system receive requests from builders of Web pages.

(Details of Processing Contents-Authentication Processing)

Under the assumption, the browsers have access to the Internet 3 through the server device 1 after logging on the server device 1, and may make a transmission request of different types of Web data to the Web server 4.

Specifically, the browsers activate the Web browser 20a of the client device 2, specifies the user IDs and the passwords, and performs dial-up connection request to the server device 1. The connection request is performed according to, for example, a communication protocol such as PPP (Point-to-Point Protocol).

On the other hand, the request interpretation section 16a of the server device 1 monitors the presence of transmission from the client device 2, and, when the transmission is received, analyzes transmitted contents after establishing the connection to the client devices 2, and transfers the processing to each section in the control section 16 according to the analyzed results. When the transmitted contents indicate a connection request, the processing is delivered to the authentication-processing section 16b.

The authentication-processing section 16b performs authentication of the browsers according to the user authentication protocol such as PAP (Password Authentication Protocol) and CHAP (Challenge-Handshake Authentication Protocol). Here, authentication of the browsers is performed at least by judging whether a combination of the transmitted user ID and password is in agreement with any one of combinations of the user IDs and the passwords which have been stored in the member DB 10. Then, the connection is intercepted, when the authentication is not admitted. On the other hand, the client device 2 is connected as a client to the Internet, when the authentication is admitted.

(Details of Processing Contents-Incentive Specifying/Storing Processing)

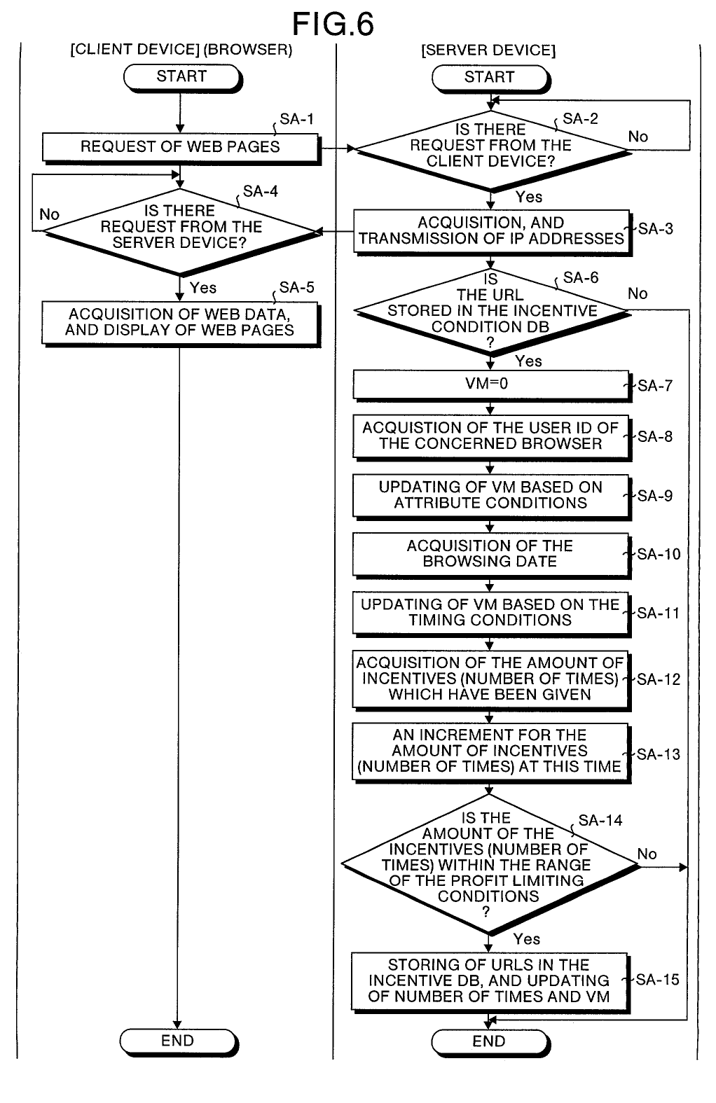

Subsequently, incentive specifying/storing processing is performed, whenever the browsers browse the Web data. A flow chart for the processing is shown in FIG. 6. In FIG. 6, the browsers input a URL of a Web page, which the browsers themselves want to browse, into a predetermined input field in the Web browser 20a for transmission. Then, when updating the screen is instructed, the Web browser 20a transmits the URL through the communication control IF 27 according to a predetermined communication protocol, and the transmission request of the Web page to the server device 1 is made by routing based on the URL (step SA-1).

The request interpretation section 16a of the server device 1 monitors the presence of transmission from the client device 2 (step SA-2), and, when the transmission is received, analyzes transmitted contents, and transfers the processing to each section in the control section 16 according to the analyzed results. When the transmitted contents indicate a browsing request of a Web page, the browsing processing section 16c performs address solution of the URL, and returns an IP address obtained as the solution result to the Web browser 20a (step SA-3).

The Web browser 20a has an access to the Web server 4 where Web data have been stored, using the IP address, and acquires Web data from the Web server 4. The Web data are interpreted in the Web browser 20a, and, thereafter, a Web page is displayed on the monitor 25 (step SA-4 and SA-5).

Processing is delivered to the incentive-process section 16d of the server device 1, after the address solution and the transmission of the IP address. The incentive-process section 16d performs processing for specifying the contents of the incentives which are given to the browsers, and processing for storing the contents of the incentives specified by the processing in the incentive DB 13.

Specifically, the incentive-process section 16d judges whether the URL of the Web page for which the browser has performed the browsing request has been stored in the incentive-condition DB 11 (step SA-6). Then, the processing is terminated, as the browsed Web page may be judged not to be specified as objects for incentives to be given in the case of no storage. On the other hand, VM which is the contents of the incentives are set in the first place as an initial value 0 (but, the initial value is arbitrary) (step SA-7) when the URL is stored, and thereafter, the contents of the incentives are specified based on the incentive conditions.

The specifying is performed based on the attribute conditions.

Therefore, the incentive-process section 16d acquires the user IDs of the browsers (step SA-8). For example, user IDs which have been transmitted at authentication of the browsers may be used for the user IDs. Then, the incentive-process section 16d refers to the incentive-condition DB 11 based on the user IDs and updates the VM of the browsers based on the attribute conditions (step SA-9).

Specifically, the VM is updated by adding the VM=1 to the VM=0 in the case of the attribute conditions in FIG. 3, as VM=1 is given to a browser when the user ID of the browser who has referred to the Web page of “URL=http://www.a-” is “UID0005”. On the other hand, the VM is updated by adding the VM=0 to the VM=0 as VM=0 is given to a browser when the user ID of the browser is not “UID0005”.

The contents of the incentives are specified, based on the timing conditions.

Therefore, the incentive-process section 16d acquires dates when the browsers have browsed the Web pages (step SA-10). Then, the incentive-process section 16d refers to the incentive-condition DB 11 based on the dates, and updates the VM of the browsers based on the timing conditions (step SA-11).

Specifically, the VM is updated in the case of the attribute conditions in FIG. 3 by adding the VM=3 to the VM which browsers have currently had, as VM=3 is given to the browsers when the timing at referring to the Web page of “URL=http://www.b-” is between “2000.7.1-2000.8.31”. On the other hand, the VM is updated by adding the VM=1 to the VM which browsers have currently had, as VM=1 is given to the browsers when the timing is not between “2000.7.1-2000.8.31”.

The incentive-process section 16d judges based on the incentive-limiting conditions stored in the incentive-limiting condition DB 12 whether incentive limitation is required or not.

The amount of the incentives (here, number of times the incentives have been received) which the browsers have currently received by browsing the concerned Web page is called, referring to the incentive DB 13 based on the user IDs of the browsers and the URLs of the Web pages which the browsers have browsed (step SA-12). For example, it is understood in FIG. 5 that the incentives have been received once, when the user ID is “UID0001”, and the URL is “http://www.a-”.

The amount of the incentives given by browsing the Web pages at this time is incremented to the called number of times (step SA-13). In the case of the example, a number of times to be received at this time as the incentives is incremented to the number of times the incentives have been received so far, and the total number=2 is obtained.

It is judged, referring to the incentive-limiting conditions for the concerned Web page, which have been stored in the incentive-limiting condition DB 12, whether the amount of the incentives (number of times) given to the browsers is within the range of the incentive-limiting conditions (step SA-14). In the case of the example, it is judged that the number of times is exceeding the range of the incentive-limiting conditions, as the incentive-limiting condition for the Web page with a URL of “http://www.a-” is one time, and the number of times which is given to the browsers is two times.

In this case, it is judged that further new incentives may not be given, and the processing is terminated without updating the VM (without recording the further new incentives) On the other hand, when the range of the incentive-limiting conditions is not exceeded, it is judged that further new incentives may be given, and processing for recording the incentives is performed. That is, the URLs which the browsers have browsed are stored in the incentive DB 13, and, at the same time, number of times the incentives corresponding to the URLs have been received is incremented by one. Moreover, the total sum of the VM is updated, using the newly obtained VM. Then, the processing is terminated.

The processing is repeated whenever browsers browse Web data, and the VM for the browsers is accumulated, according to the contents.

(Details of Processing Contents-Browsing Processing of Acquired VM)

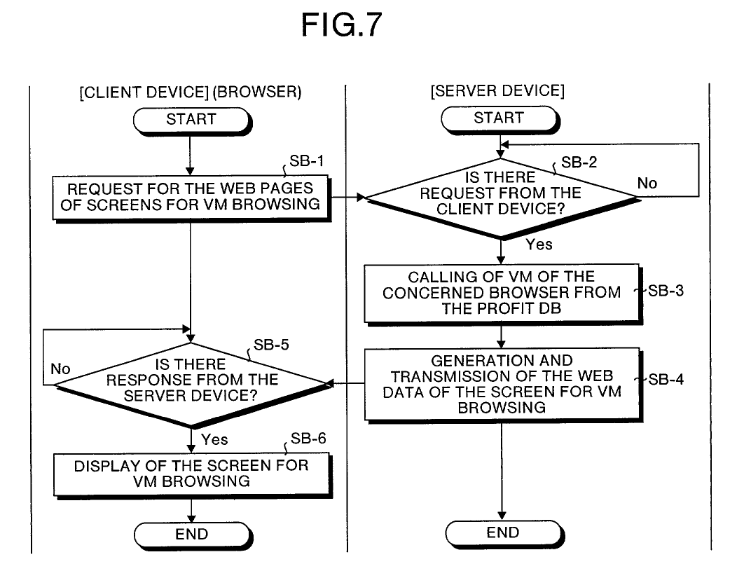

The browsers may browse at arbitrary timing the VM which the browsers themselves have currently acquired. A flow chart for the browsing processing is shown in FIG. 7. In FIG. 7, the browser requests a Web page as the browsing screen for browsing the own VM, using the Web browser 20a(step SB-1) . A method for the requesting is arbitrary, and the requesting may be realized, for example, by providing on a predetermined Web page, which is established by a builder of the present system, an instruction button for requesting VM browsing, and by selecting the instruction button with the input device 24.

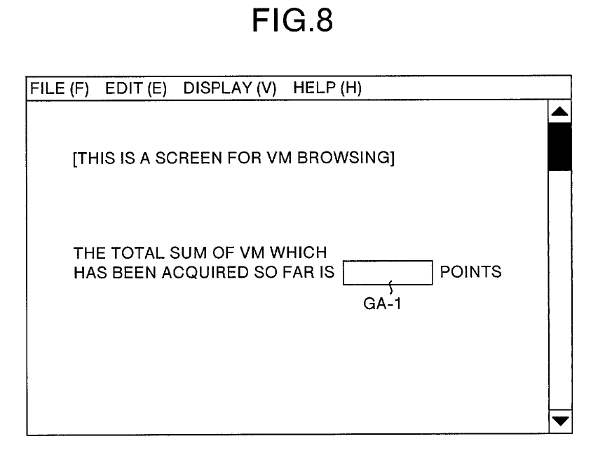

When the request interpretation section 16a of the server device 1 receives the browsing request, the processing is delivered to the browsing processing section 16c. The browsing processing section 16c calls the total sum of the VM stored in the incentive DB 13 (step SB-2 and SB-3), referring to the incentive DB 13 based on the user IDs of the concerned browser. Then, Web data for browsing screens to browse the total sum of the VM are generated, using the total sum of the VM, and transmitted to the client device 2 (step SB-4). As a result, the browsing screens are displayed on the monitor 25 (step SB-5 and SB-6). The display example of the VM browsing screens is shown in FIG. 8. In FIG. 8, the VM browsing screen has a configuration where a display field GA-1 for the VM which the browsers have currently acquired is included.

According to the processing, the browser may easily confirm the VM which the browsers themselves have acquired.

(Details of Processing Contents-Using Processing of Acquired VM)

The browsers may use the VM which the browsers themselves have acquired. As various kinds of methods for use of such virtual money on a network have been already proposed, and have been also put into practical use, description of the specific contents is eliminated here.

For example, the browsers specifies a method using the VM as a method for paying the purchase price of commodities in an electronic commerce site tied up with the present system, and inputs the own user IDs and passwords. Subsequently, inquiry for acceptance authentication is made to the present system based on the information, and, in the present system, authentication of the browsers is performed, using the user IDs and passwords, and, at the same time, it is judged whether the VM to be used by the browsers is stored in the incentive DB 13. Then, when the authentication is admitted, and the VM is stored in the incentive DB 13, the admission of the acceptance is transmitted to the electronic commerce site, and, at the same time, the used VM is subtracted from the VM stored in the incentive DB 13 for updating the balance.

Cash is automatically transferred to specified accounts of the browsers, when the incentives given are cash, and gift certificates may be automatically sent to addresses of the browsers, when the incentives are gift certificates. Moreover, an operator judges the contents of the incentive DB 13, and the operator may perform manual transfer of cash and delivery of gift certificates.

Though the embodiment according to the present invention has been described, the present invention may be applied to various different kinds of embodiments, as well as the embodiment, within a technical scope described in the aspects of the present invention.

For example, though there has been a description in the embodiment that the server device 1 is configured to be as an ISP server which an ISP has, similar incentives to those of the embodiment may be provided for browsing of Web pages on the WWW through arbitrary ISPs and dedicated lines. In the case, information for specifying the browsers, or information for specifying the browsed Web pages may be acquired, for example, from ISP servers which the browsers are using, and Web servers which have stored browsed Web pages.

The information at log-on of the browsers as a member may be used, and, in addition, Cookie files (Cookies) stored in the client device may be employed, or, an IP address specially allocated to the client device in dedicated line connection may be used as information for specifying the browsers.

All kinds of or a part of processing, among processing, which is described in the embodiment, to be performed automatically may be performed manually, or, all kinds of or a part of processing, among processing, which is described in the embodiment, to be performed manually may be performed automatically.

Information including parameters such as processing procedures, control procedures, specific names, various kinds of registered data, and retrieval conditions may be arbitrarily changed, except when there is a special note.

As described above, according to the first, second, eighth, or eleventh aspect of the present invention, contents of incentives given to browsers are specified, and stored in a device for providing information, when information is browsed. That is, when browsers browse information, predetermined incentives (for example, cash, virtual money, and so on, and the details will be described later) are given to the browser. Accordingly, incentives may be directly given to browsers, and entirely new incentives for making browsers browse Web pages may be given.

According to the third, ninth, or eleventh aspect of the present invention, incentive conditions for specifying the contents of incentives are stored, and the contents of the incentives are specified based on the incentive conditions. Accordingly, arbitrary incentives in agreement with intentions of Web page providers, those who establish the system, and so on may be given by appropriately setting the incentive conditions.

According to the fourth aspect of the present invention, attribute conditions for attributes of browsers are stored, and the contents of the incentives are specified based on the attribute conditions. Accordingly, incentives according to browsers may be given, for example, incentives may be given only to specified browsers, and contents of incentives may be changed according to genders and ages and so on of browsers.

According to the fifth aspect of the present invention, timing conditions for browsing timing by browsers are stored, and contents of incentives are specified, based on the timing conditions. Accordingly, incentives according to the browsing timing may be given, for example, incentives are given only when browsing is performed during specific period, or amounts of incentives may be changed according to the browsing timing.

According to the sixth, tenth or eleventh aspect of the present invention, incentive-limiting conditions for limiting contents of incentives are stored, and the contents of incentives are limited based on the incentive-limiting conditions. Accordingly, incentive-limiting in agreement with intentions of Web page providers, those who establish the system, and so on may be performed by appropriately setting the incentive-limiting conditions.

A device for providing information according to the seventh aspect of the present invention stores conditions for the amount of incentives which have been acquired by browsers, or number of times which the browsers have acquired the incentives, and the contents of incentives are limited within the range of the amount of incentives, or the number of times.

Accordingly, for example, it is possible that the incentives are given to a same browser only once, the total sum of the incentives is limited to 10,000 yen or less, and so on, as the incentives which are given to the browsers are limited with in a predetermined amount of money, or number of times.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A system for providing incentives to users who browse information through a computerized network comprising:
an information terminal device for browsing different types of information; and
an information providing device for providing information to the information terminal device through the network, wherein, said information providing device includes:
an incentive-information database for storing incentive-information to represent contents of incentives given to the users who browse information with the information terminal device; and
an incentive-process means for specifying the contents of incentives based on the user who browses information or the information terminal device used to browse information, and information which the users browse, and for storing incentive-information in the incentive-information database.

2. The system according to claim 1, wherein,
the information providing device is a web server,
the information provided by the information providing device are different types of web pages, and
the computerized network is the Internet.

3. An information providing device for providing different types of information to an information terminal device through a computerized network comprising:
an incentive-information database for storing incentive-information to represent contents of incentives given to the users who browse information with the information terminal device; and
an incentive-process means for specifying the contents of incentives, based on the user who browses information or the information terminal device used to browse information, and information which the users browse, and for storing incentive-information in the incentive-information database.

4. The information providing device according to claim 3, further comprising:
an incentive-condition database for storing incentive-conditions for specifying the contents of incentives, wherein:
the incentive-process means specifies the contents of incentives based on the incentive-conditions stored in the incentive-condition database.

5. The information providing device according to claim 4, wherein,
the incentive-conditions stored in the incentive-condition database are attribute conditions relating to predetermined attributes of predetermined said ones of users, and
the incentive-process means specifies the contents of incentives based on the attribute conditions stored in the incentive-condition database.

6. The information providing device according to claim 4, wherein,
the incentive conditions stored in the incentive-condition database are timing conditions relating to browsing times of said users, and
the incentive-process means specifies the contents of incentives based on the timing conditions stored in the incentive-condition database.

7. The information providing device according to claim 3, comprising:
an incentive-limiting-condition database for storing incentive-limiting-conditions for limiting the contents of incentives, wherein:
the incentive-process means limits the contents of incentives based on the incentive-limiting-conditions stored in the incentive-limiting-condition database.

8. The information providing device according to claim 7, wherein,
the incentive-limiting-conditions are conditions for the amount of incentives which said users have acquired, or the number of times which said users have acquired the incentives, and
the incentive-process means limits the contents of incentives within the range of the amount of incentives or the number of times based on the incentive-limiting-conditions.

9. The information providing device according to claim 3, wherein,
the information providing device is a web server,
the information provided by the information providing device are different types of web pages, and
the computerized network is the Internet.

10. A method for providing incentives to users who browse information in a system including: an information terminal device for browsing different types of information; and an information providing device for providing information to the information terminal device through a network, comprising the steps of:
(a) acquiring information from network for specifying the users who browse information or the information providing device used to browse information;
(b) specifying the contents of incentives to be given to the users based on the information acquired in the acquiring step (a); and
(c) storing incentive-information in the information providing device to specify the contents of incentives specified in the specifying step (b).

11. The method incentives to users who browsed different types of according to claim 10, comprising the further steps of:
in said information providing device storing incentive-conditions for specifying the contents of incentives, in said information providing device, wherein,
the contents of the incentives specified in the specifying step (b) are based on the incentive-conditions.

12. The method according to claim 10, comprising the further steps of:
storing the incentive-limiting-conditions, which are conditions for limiting the contents of incentives, in said information providing device, wherein,
the contents of incentives are limited in the specifying step (b), based on the incentive-limiting-conditions.

13. The method according to claim 10, wherein,
the information providing device is a web server,
the information provided by the information providing device are different types of web pages, and
the computerized network is the Internet.

14. A computer-readable recording medium, comprising a computer program for a computer to execute the method for providing information according to any one of claims 10 to 13 is recorded.
